(19) United States
(12) Patent Application Publication
(10) Pub. No.: US 2018/0181250 A1
(43) Pub. Date: Jun. 28, 2018

(54) DISPLAY DEVICE AND MANUFACTURING METHOD THEREOF

(71) Applicant: ACER INCORPORATED, New Taipei City (TW)

(72) Inventor: Jin-Ting Kuo, New Taipei City (TW)

(21) Appl. No.: 15/436,737

(22) Filed: Feb. 17, 2017

(30) Foreign Application Priority Data
Dec. 22, 2016 (TW) 105142823

(51) Int. Cl. G06F 3/041

(52) U.S. Cl. CPC G06F 3/0416; G06F 2203/04107; G06F 2203/04103

(57) ABSTRACT

A display device includes a substrate with a first surface and a second surface, a light guide structure disposed on the first surface of the substrate, and a touch sensing module disposed on the first surface of the substrate; wherein the light guide structure and the touch sensing module are disposed in a staggered and non-overlapping manner with respect to each other on the substrate.

### BACKGROUND OF THE INVENTION

### 1. Field of the Invention

The present invention relates to a display device and a manufacturing method, and more particularly, to a display device and a manufacturing method capable of maintaining the light guiding performance and avoiding incorrect touch sensing.

### 2. Description of the Prior Art

Compact designs and low power consumptions may be realized in reflective display devices because backlight units are not required for the reflective display devices. Thus, wearable devices or electronic devices for reading (e.g., electronic books) often employ reflective displays for displaying nowadays. Moreover, since the reflective display device itself does not emit light, the reflective display device would be suitable for long time reading, but unsuitable for reading in the dark environments. Therefore, a light guide plate and a light source are added to the surface of the display device for users to read in the dark environments. On the other hand, a touch input function is commonly utilized on electronic devices and provides a more natural and more instinctive way for users to interact with the electronic devices.

Please refer to FIG. 1, which is a schematic diagram illustrating a conventional display device 10. The display device 10 includes a display panel 100, a touch sensing layer 102, a light guide plate 104 and a light source unit 106. Since the touch sensing layer 102 is disposed between the display panel 100 and the light guide plate 104, the light 108 emitted from the light source unit 106 is guided by the light guide plate 104 and must also pass through the touch sensing layer 102 to the display panel 100. As such, the light guiding performance of the light guide plate 104 will be influenced, thus increasing the optical (light) loss. In addition, the light guide plate 104 disposed upon the touch sensing layer 102 may cause incorrect touch sensing. Thus, there is a need for improvement.

### SUMMARY OF THE INVENTION

It is therefore an objective of the present invention to provide a display device and a manufacturing method capable of maintaining the light guiding performance and avoiding incorrect touch sensing to solve the above mentioned problems.

The present invention discloses a display device, comprising a substrate with a first surface and a second surface, a light guide structure disposed on the first surface of the substrate, and a touch sensing module disposed on the first surface of the substrate; wherein the light guide structure and the touch sensing module are disposed in a staggered and non-overlapping manner with respect to each other on the substrate.

The present invention further discloses a manufacturing method of a display device, comprising providing a substrate with a first surface and a second surface; forming a light guide structure on the first surface of the substrate; and forming a touch sensing module on the first surface of the substrate; wherein the light guide structure and the touch sensing module are disposed in a staggered and non-overlapping manner with respect to each other on the substrate.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a conventional display device.

FIG. 2 is a schematic diagram illustrating a top view of a portion of a display device according to an embodiment of the present invention.

FIG. 3 is a schematic diagram illustrating a cross-sectional view along a line A-A′ shown in FIG. 2.

FIGS. 4 and 5 are schematic diagrams illustrating arrangements of the light guide structures according to embodiments of the present invention.

FIG. 6 is a schematic diagram illustrating arrangements of the light guide structures and the light source units according to an embodiment of the present invention.

FIGS. 7-15 are schematic diagrams illustrating manufacturing methods of the light guide structures and the touch sensing modules according to embodiments of the present invention.

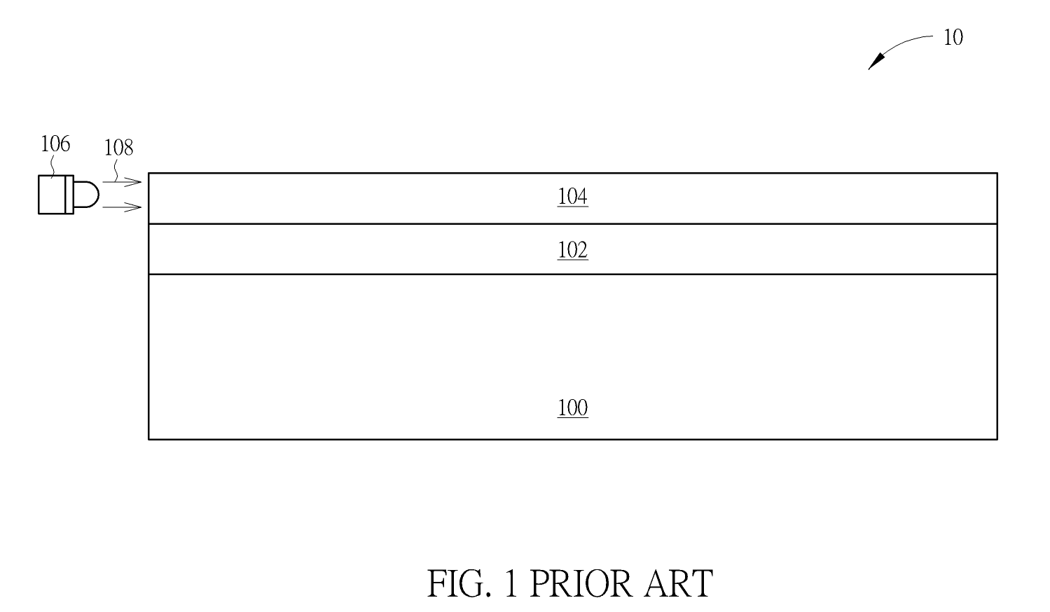

### DETAILED DESCRIPTION

Certain terms are used throughout the description and following claims to refer to particular components. As one skilled in the art will appreciate, hardware manufacturers may refer to a component by different names. This document does not intend to distinguish between components that differ in name but not function. In the following description and in the claims, the terms “include” and “comprise” are utilized in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

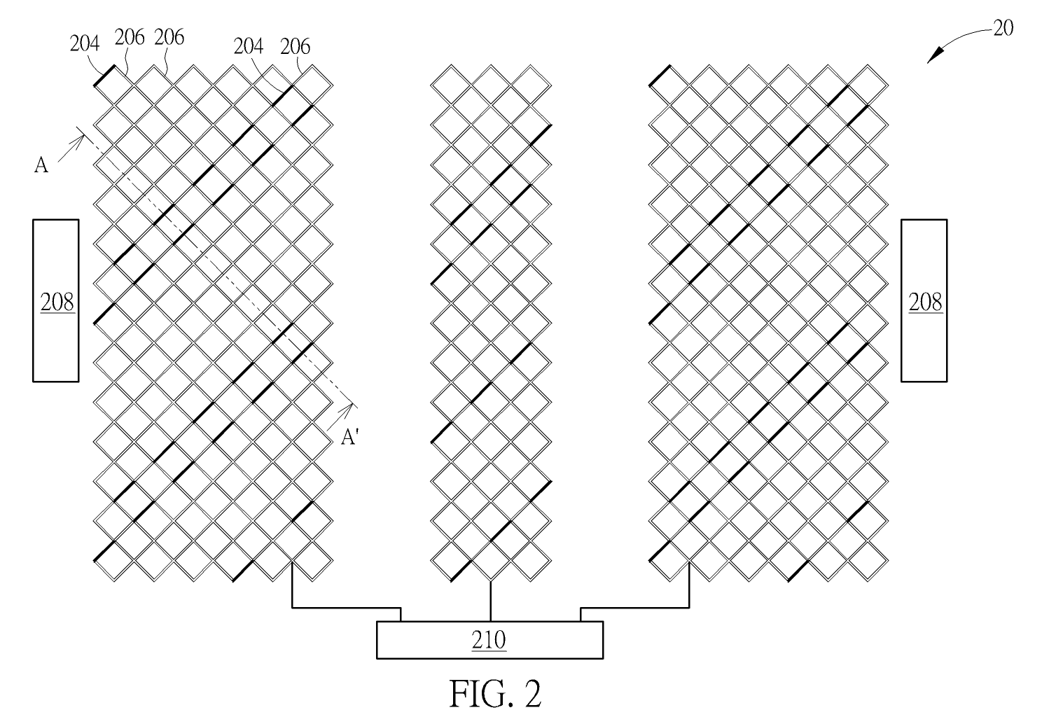

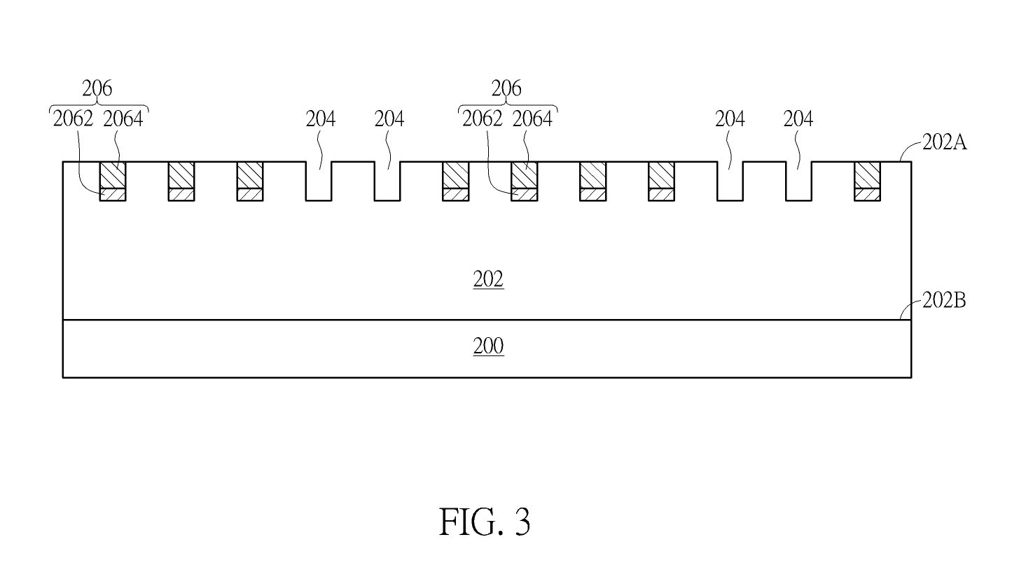

Please refer to FIG. 2 and FIG. 3. FIG. 2 is a schematic diagram illustrating a top view a portion of a display device 20 according to an embodiment of the present invention. FIG. 3 is a schematic diagram illustrating a cross-sectional view along a line A-A′ shown in FIG. 2. The display device 20 can be applied in various electronic devices, such as smart watches, smart bracelets, smart glasses, wearable devices, head-mounted devices, portable electronic devices, but not limited thereto. The display device 20 includes a display panel 200, a substrate 202, light guide structures 204, touch sensing modules 206, light source units 208 and a touch controller 210. The display panel 200 can be a reflective display panel. The substrate 202 is disposed on the display panel 200. Preferably, the substrate 202 can be a transparent substrate, such as a glass substrate, an acrylic substrate, but this should not be a limitation of the invention. Furthermore, the substrate 202 can be integrated with the display panel 200. For example, the substrate 202 can be a component of the display panel 200 or a portion of the display panel 200. For example, the substrate 202 can be a cover glass of the display panel 200. The substrate 202 includes a first surface 202A and a second surface 202B.

The light guide structures 204 are utilized for guiding the light emitted by the light source units 208 to the display panel 200. The light guide structures 204 may include a plurality of optical micro-structures for guiding light. The touch sensing module 206 include a shielding layer 2062 and a touch electrode layer 2064. As shown in FIG. 3, the shielding layer 2062 is formed on the first surface 202A of the substrate 202, and the touch electrode layer 2064 is also formed on the shielding layer 2062. The touch electrode layer 2064 can generate corresponding touch signals in response to operations of an object on or nearby the touch electrode layer 2064. The shielding layer 2062 is utilized for shielding (e.g., blocking and/or reflecting) the light. For example, the shielding layer 2062 can shield the light passing through the touch electrode layer 2064 or the light reflected from the touch electrode layer 2064. As such, the touch electrode layer 2064 would not be seen by the user when using the display device 20 and thus providing a more attractive and user-friendly experience for the user. In an embodiment, the touch sensing modules 206 can be capacitive touch sensors, resistive touch sensors, electromagnetic touch sensors, surface acoustic wave touch sensors, piezoelectric touch sensors, optic touch sensors or any other types of touch sensing device. The light source unit 208 is utilized for providing light. The touch controller 210 is coupled to the touch sensing modules 206 for receiving the touch signals generated by the touch electrode layer 2064 and accordingly determining touch events.

In more detail, the light guide structures 204 are disposed on the first surface 202A of the substrate 202. The touch sensing modules 206 are also disposed on the first surface 202A of the substrate 202. The light guide structures 204 and the touch sensing modules 206 are disposed and formed on the same surface of the substrate 202. The light guide structures 204 and the touch sensing modules 206 are disposed in a staggered and non-overlapping manner with respect to each other on the substrate 202. In other words, the light guide structures 204 and the touch sensing modules 206 are both disposed on the same surface of the substrate 202 and formed on the same layer. The light guide structures 204 and the touch sensing modules 206 are integrated into the same structure. Furthermore, the light emitted from the light source units 208 enters and passes through the light guide structures 204, and is transmitted to the display panel 200. As such, since the light guide structures 204 and the touch sensing modules 206 are disposed in the staggered and non-overlapping manner with respect to each other, the light passing through the light guide structures 204 will not be influenced by the touch sensing modules 206. The touch sensing modules 206 will not be influenced by the light guide structures 204 so as to perform accurate touch sensing operations. Therefore, the display device of the embodiment can substantially reduce the overall thickness of the display device since the light guide structures 204 and the touch sensing modules 206 are disposed on the same layer, maintain the light guiding performance of the light guide plate 104 without optical loss and avoid incorrect touch sensing.

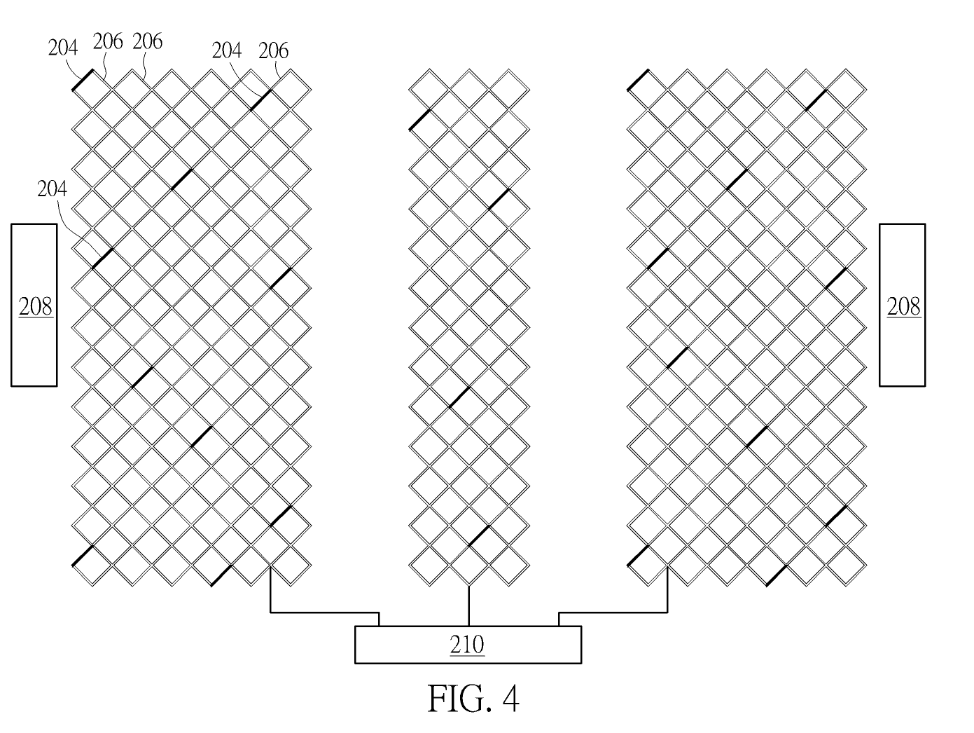

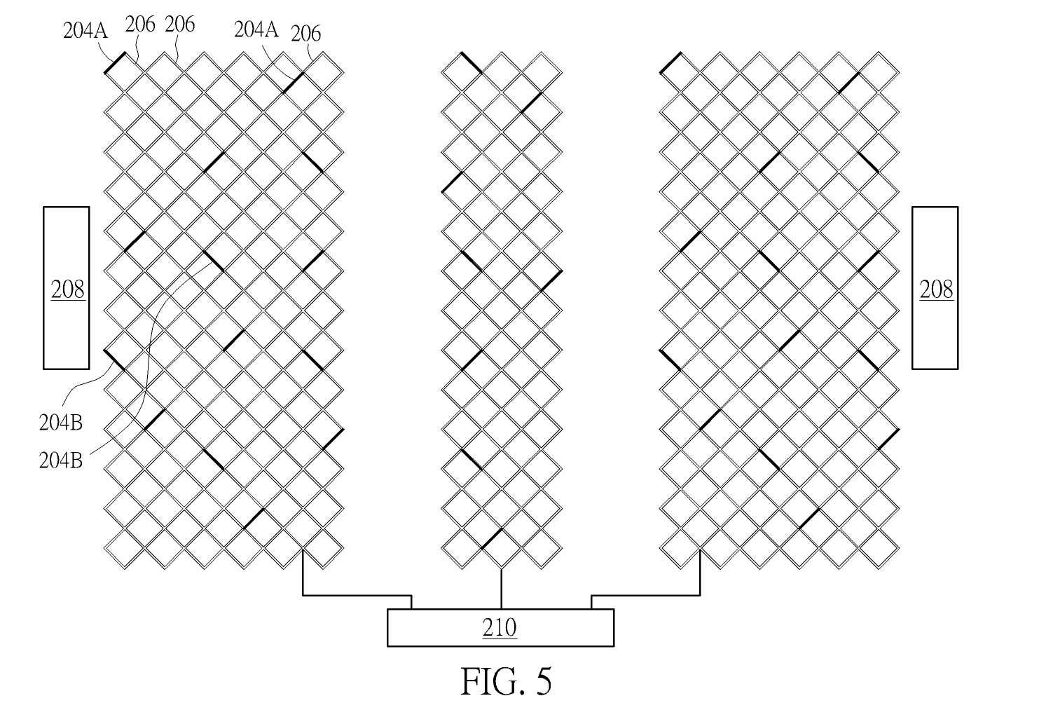

On the other hand, for maintaining high manufacturing yield and avoiding low wire impedance of the touch sensing, the light guide structures 204 can be formed on a patterned structure with segments. Preferably, each of the light guide structures 204 can be arranged at a distance from each other, to avoid affecting the brightness. Please refer to FIG. 4 and FIG. 5, which are schematic diagrams illustrating arrangements of the light guide structures 204 according to embodiments of the present invention. As shown in FIG. 4, each of the light guide structures 204 and the touch sensing modules 206 is independently disposed on an independent line segment of a grid cell of a mesh pattern. The light guide structures 204 and the touch sensing modules 206 are disposed in the staggered and non-overlapping manner with respect to each other. The distance between each two adjacent light guide structures 204 is at least 3 line segments of the grid cell of the mesh pattern. As shown in FIG. 5, each of the light guide structures 204A, the light guide structures 204B and the touch sensing modules 206 is independently disposed on the line segment of the grid cell of the mesh pattern. The distance between each light guide structure 204A and its adjacent light guide structure (the light guide structure 204A or the light guide structure 204B) is at least 2 line segments of the grid cell of the mesh pattern. The distance between each light guide structure 204B and its adjacent light guide structure (the light guide structure 204A or the light guide structure 204B) is at least 2 line segments of the grid cell of the mesh pattern.

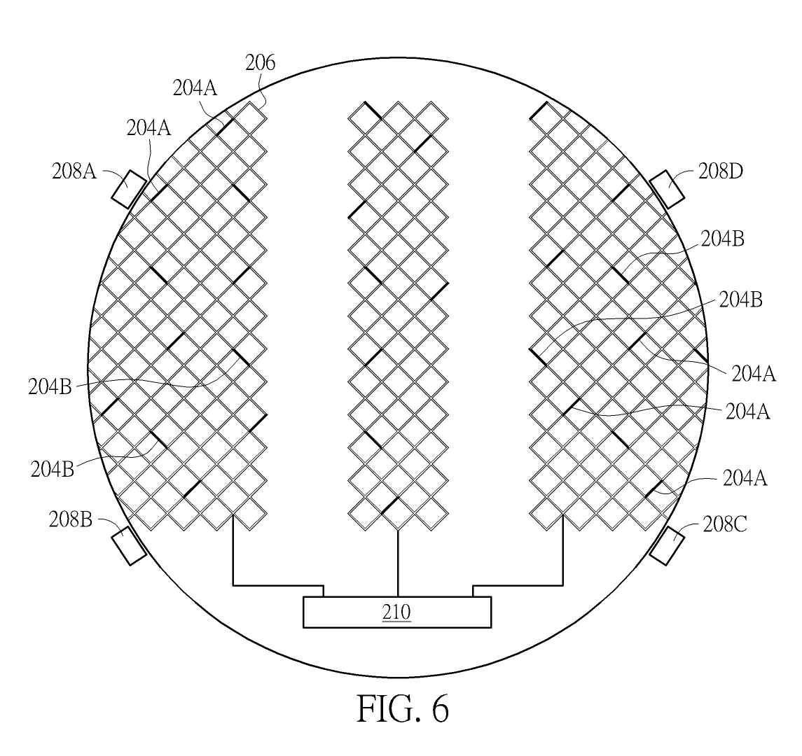

Moreover, for enhancing the light guiding performance, an angle between the light emitted from a light source unit and a direction of a long edge of a light guide structure is in a range of 30 degrees to 90 degrees. For example, please refer to FIG. 6, which is a schematic diagram illustrating arrangements of the light guide structures and the light source units of the present invention. The light emitted from the light source unit 208A, 208C and the direction of the long edge of the light guide structures 204A are perpendicular to each other. The light emitted from the light source unit 208B, 208D and the direction of the long edge of the light guide structures 204B are perpendicular to each other. As such, most of the light emitted from the light source units can enter the light guide structures light and be guided to the display panel 200, thus effectively increasing the light guiding performance. In addition, an angle between the light emitted from a light source unit and an incident plane of a light guide structure is in a range of 30 degrees to 90 degrees.

Besides, please further refer to FIG. 6. An embodiment of the present invention provides a power-saving design. In a normal mode, all of the light source units 208A, 208B, 208C and 208D can be turned on. In a power-saving mode, only the light units 208A, 208C are turned on or only the light units 208B, 208D are turned on. In an extreme power-saving mode, only one of the light units 208A, 208B, 208C and 208D can be turned on.

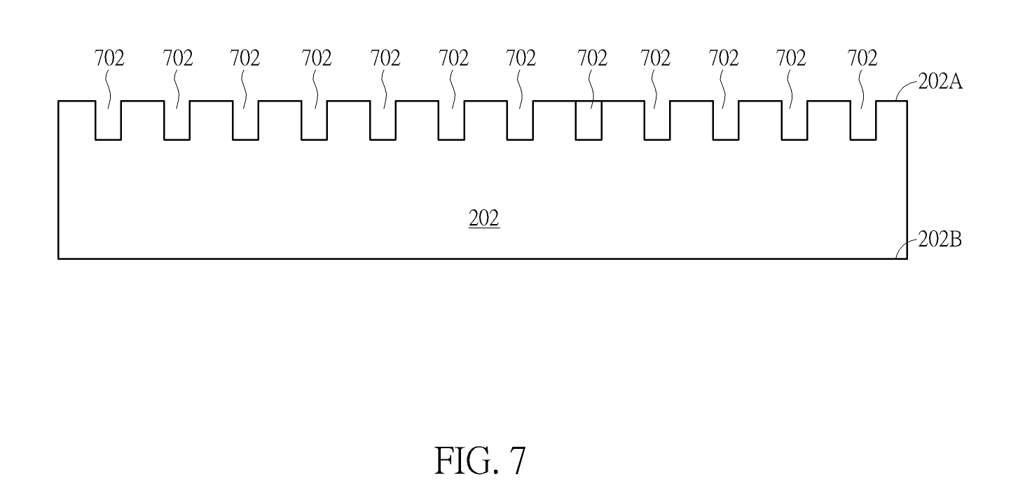

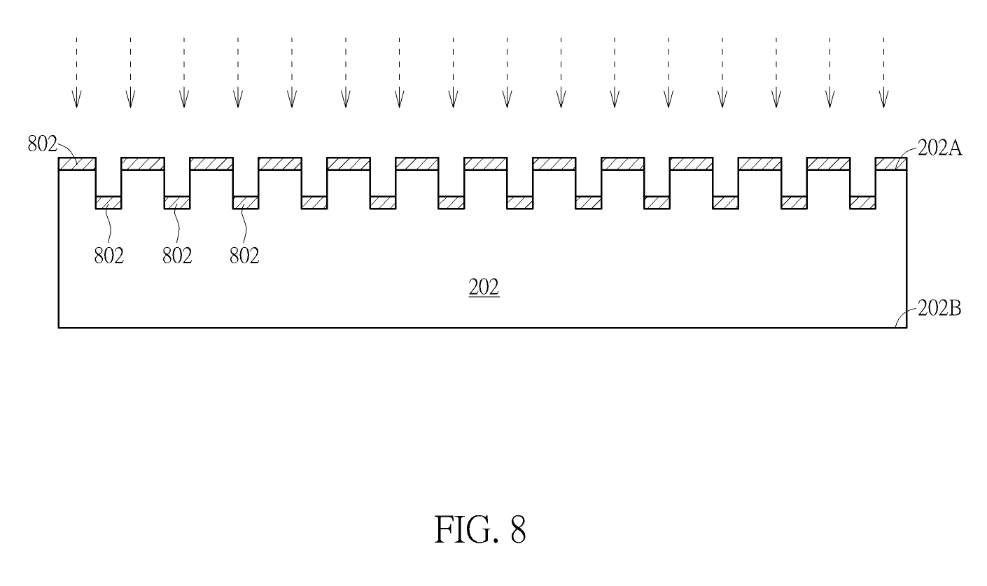

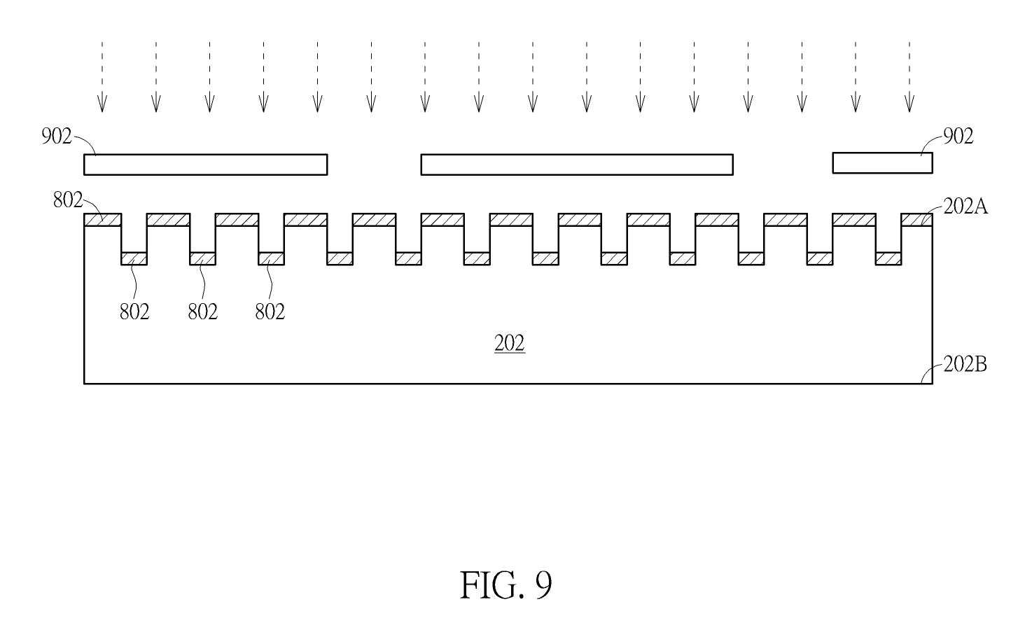

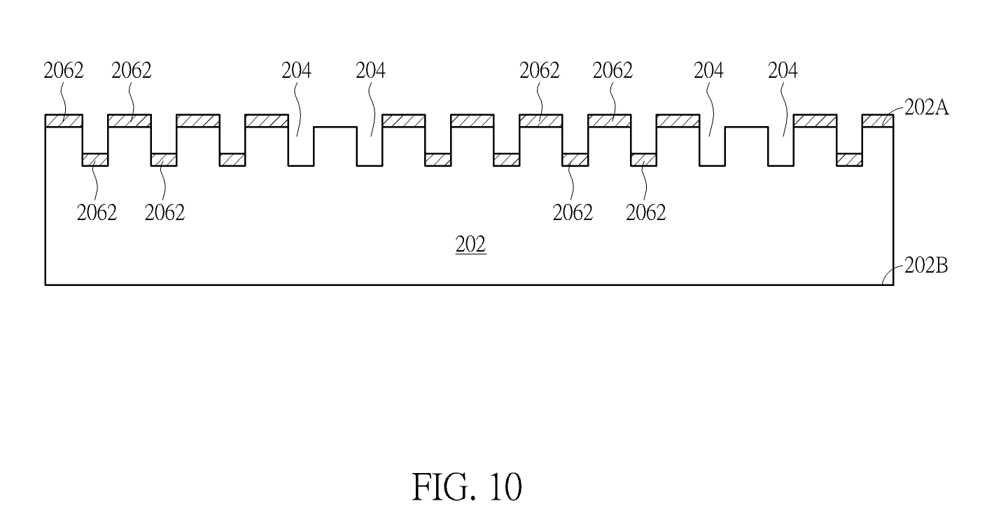

Please refer to FIGS. 7-15. FIGS. 7-15 are schematic diagrams illustrating the manufacturing methods of the light guide structures 204 and the touch sensing modules 206 according to embodiments of the present invention. An embodiment of the present invention provides a manufacturing method of the light guide structures 204 and the touch sensing modules 206 of the display device 20, which includes the following steps. First, as shown in FIG. 7, a substrate 202 is provided. The substrate 202 can be a transparent substrate, such as a glass substrate, but not limited thereto. The substrate 202 has the first surface 202A and the second surface 202B. Then, a plurality of trenches 702 are formed on the first surface 202A of the substrate 202. For example, when manufacturing the substrate 202, a mold injection process can be performed to form the trenches 702 or an etching process can be performed to form the trenches 702 on the first surface 202A of the substrate 202. After that, as shown in FIG. 8, a shielding layer 802 is formed on the first surface 202A of the substrate 202 and surfaces of the trenches 702, wherein the shielding layer 802 can be formed by means of evaporation deposition, electroplating, chemical plating, sputter deposition or any other types of film forming methods. A material of the shielding layer 802 can include various kinds of light proof materials, light-blocking materials and/or light-reflective materials. For example, the material of the shielding layer 802 can be a light proof organic or inorganic material. Then, as shown in FIG. 9, a mask 902 is disposed and utilized to perform an exposure development process. As shown in FIG. 10, the exposed shielding layer 802 is removed to expose the corresponding light guide structures 204, and the shielding layer 2062 is formed.

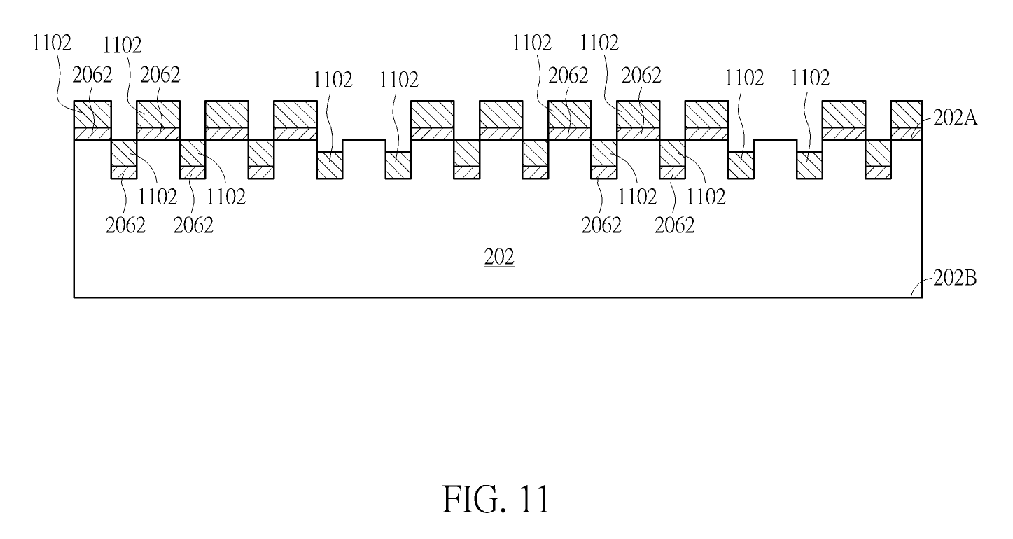

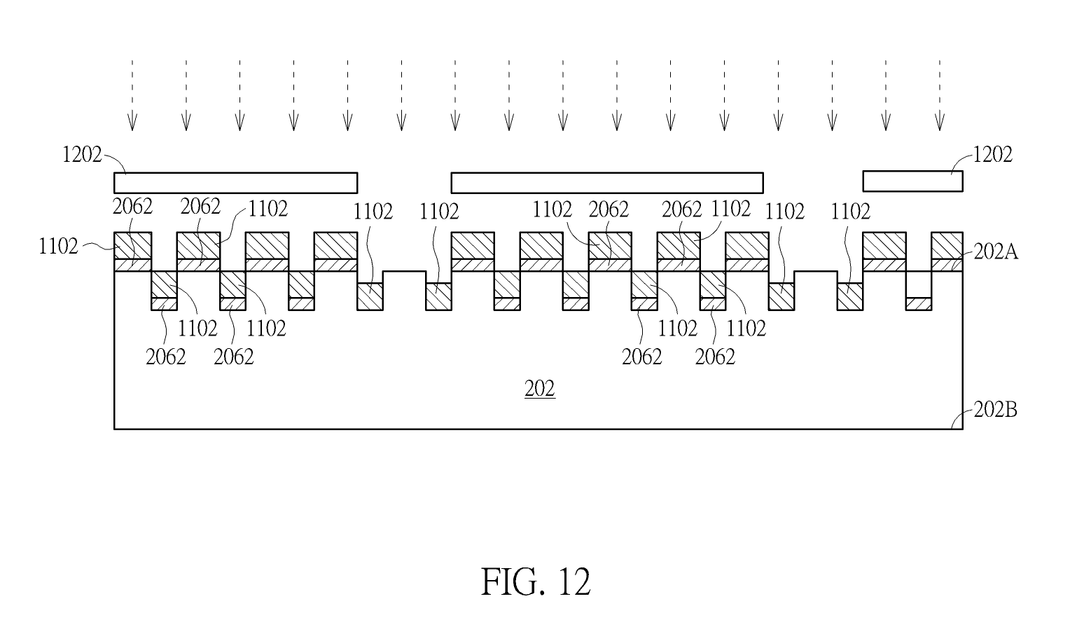

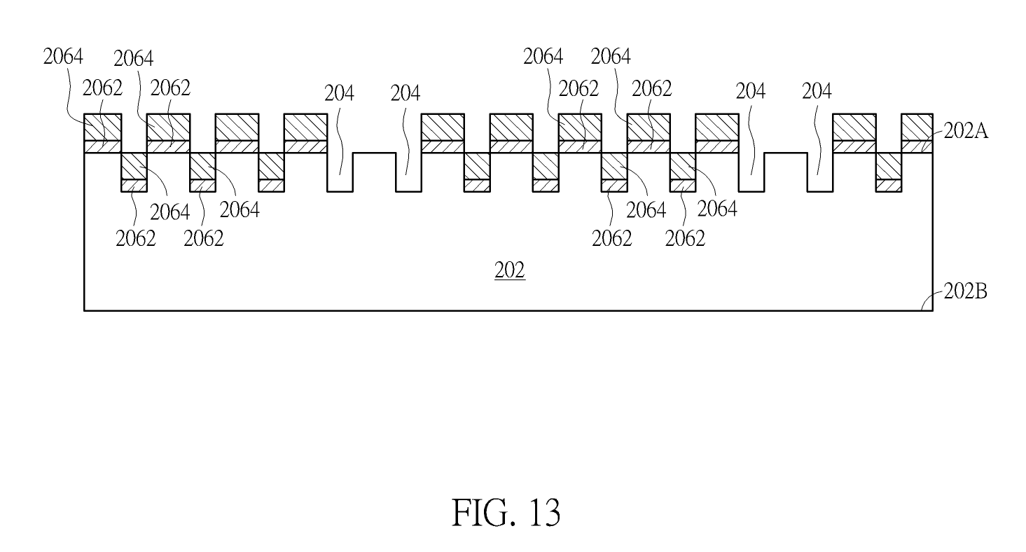

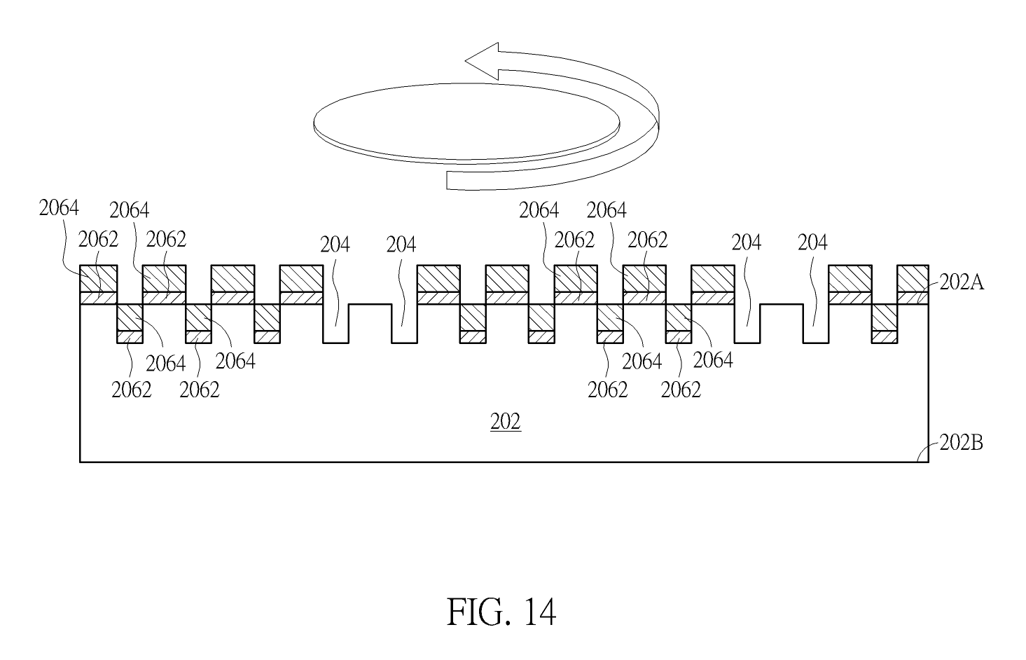

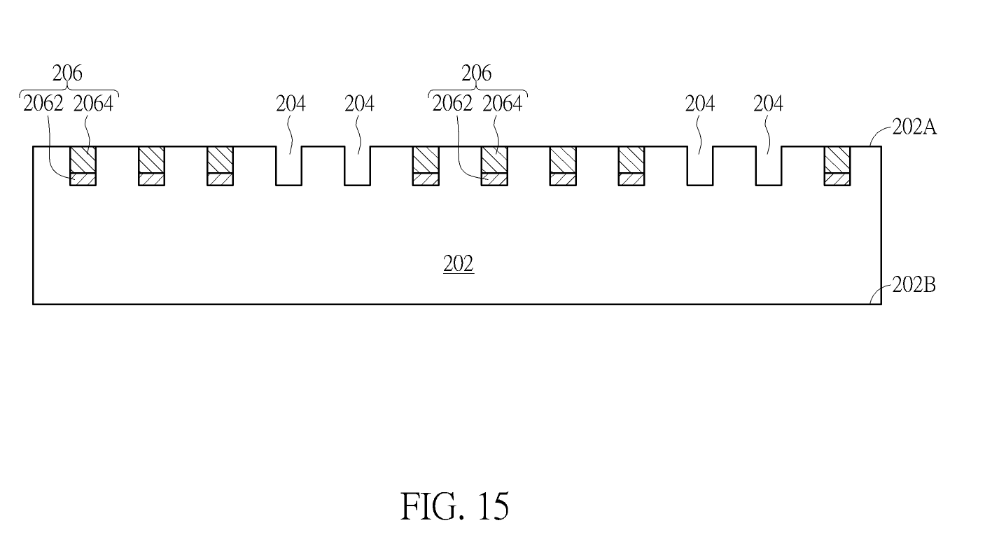

As shown in FIG. 11, a touch electrode layer 1102 is formed on the surface of the light guide structures 204 and the non-etched shielding layer 2062, wherein the touch electrode layer 1102 can be formed by means of evaporation deposition, electroplating, chemical plating, sputter deposition or any other types of film forming methods. A material of the touch electrode layer 1102 can include all kinds of conductive materials. For example, a material of the touch electrode layer 1102 can be a transparent conductive material, such as Indium Tin Oxide (ITO), Indium Zinc Oxide (IZO), but not limited thereto. After that, as shown in FIG. 12, a mask 1202 is disposed and utilized to perform an exposure development process. Then, as shown in FIG. 13, the exposed touch electrode layer 1102 is removed to expose the corresponding light guide structures 204, and the touch electrode layer 2064 is formed. Thus, the light guide structures 204 of the display device 20 of the present invention are completed. Then, as shown in FIG. 14, a polishing and grinding process is utilized to remove the non-etched and protruding parts (i.e. protruding parts of the first surface 202A) of the touch electrode layer. A washing process may be performed. FIG. 15 shows the light guide structures 204 and the touch sensing modules 206 including the shielding layer 2062 and the touch electrode layer 2064. In other words, through the above mentioned manufacturing method of the display panel, the light guide structures 204 and the touch sensing modules 206 disposed on the same layer shown in FIG. 15 can be completed.

In summary, the display device of the present invention can substantially reduce the overall thickness of the display device since the light guide structures 204 and the touch sensing modules 206 are disposed on the same layer, maintain the light guiding performance of the light guide plate 104 without optical loss, and avoid incorrect touch sensing.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A display device, comprising:
a substrate with a first surface and a second surface;
a light guide structure disposed on the first surface of the substrate; and
a touch sensing module disposed on the first surface of the substrate;
wherein the light guide structure and the touch sensing module are disposed in a staggered and non-overlapping manner with respect to each other on the substrate.

2. The display device of claim 1, wherein the touch sensing module comprises:
a shielding layer, disposed on the substrate; and
a touch electrode layer, disposed on the shielding layer.

3. The display device of claim 1, further comprising:
a light source unit, for emitting light, wherein the light enters the light guide structure and is transmitted to a display panel through the light guide structure.

4. The display device of claim 3, wherein an angle between the light emitted from the light source unit and a direction of a long edge of the light guide structure is in a range of 30 degrees to 90 degrees.

5. The display device of claim 1, wherein the substrate is integrated with a display panel of the display device.

6. A manufacturing method of a display device, comprising:
providing a substrate with a first surface and a second surface;
forming a light guide structure on the first surface of the substrate; and
forming a touch sensing module on the first surface of the substrate;
wherein the light guide structure and the touch sensing module are disposed in a staggered and non-overlapping manner with respect to each other on the substrate.

7. The manufacturing method of claim 6, wherein step of forming the light guide structure on the first surface of the substrate comprises:
forming a trench on the first surface of the substrate as the light guide structure.

8. The manufacturing method of claim 6, wherein step of forming the touch sensing module on the first surface of the substrate comprises:
forming a shielding layer on the first surface of the substrate and the trench;
performing a first exposure development process and a first etching process by using a first mask to form the shielding layer;
forming a touch electrode layer on the first surface of the substrate, the shielding layer and the trench; and
performing a second exposure development process and a second etching process by using a second mask proceeding to form the touch electrode layer.

9. The manufacturing method of claim 6, wherein an angle between light emitted from a light source unit and a direction of a long edge of the light guide structure is in a range of 30 degrees to 90 degrees.

10. The manufacturing method of claim 6, wherein the substrate is integrated with a display panel of the display device.
